(19) United States
(12) Patent Application Publication
(10) Pub. No.: US 2018/0285240 A1
(43) Pub. Date: Oct. 4, 2018

(54) INSTRUMENTING COMPUTER PROGRAMS FOR TELEMETRY DATA COLLECTION

(71) Applicant: Microsoft Technology Licensing, LLC, Redmond, WA (US)

(72) Inventors: Lei Kou, Redmond, WA (US); Tianzhuang Dou, Redmond, WA (US); Zhongyuan Li, Redmond, WA (US)

(21) Appl. No.: 15/478,480

(22) Filed: Apr. 4, 2017

(51) Int. Cl. G06F 11/36

(52) U.S. Cl. CPC G06F 11/3644

(57) ABSTRACT

Computer programs are dynamically instrumented for telemetry data collection. An instrumentation manifest is received that includes metadata specifying one or more target functions that exist within a target computer program which is installed on a target computing device. The metadata also specifies for each of the target functions the types of telemetry data to be collected from the target function. The manifest is utilized to insert code into each of the target functions whenever the target function is executed, where this inserted code collects the specified types of telemetry data from each of the target functions. The collected telemetry data is stored.

### BACKGROUND

Telemetry (also known as tele-metering) generally refers to the remote measurement of and data collection from a given entity. Telemetry can be used to monitor the ongoing operating status (e.g., the performance and health, along with other desired operational attributes) of many different types of entities. For example, telemetry is often used to monitor the operating status of specific computer programs. In addition to providing information about the ongoing operating status of a given computer program, telemetry data collected from the computer program can also provide information about the ecosystem in which the computer program operates.

### SUMMARY

Program instrumentation technique implementations described herein generally involve dynamically instrumenting computer programs to allow telemetry data to be collected therefrom. In one exemplary implementation an instrumentation manifest is received that includes metadata specifying one or more target functions existing within a target computer program which is installed on a computing device, where the metadata also specifies for each of the target functions one or more types of telemetry data to be collected from the target function. The instrumentation manifest is then utilized to insert code into each of the target functions whenever the target function is executed on the computing device, where this inserted code operates to collect the specified types of telemetry data from each of the target functions. The telemetry data collected by the inserted code is then stored.

In another exemplary implementation a request is received via a computer network from a target computing device to instrument a target computer program installed on the target computing device for telemetry data collection. An instrumentation manifest is then transmitted over the network to the target computing device, where this manifest includes metadata specifying one or more target functions existing within the target computer program, and the metadata also specifies for each of the target functions one or more types of telemetry data to be collected from the target function. The manifest is utilized to automatically insert code into each of the target functions whenever the target function is executed on the target computing device, where this inserted code operates to collect the specified types of telemetry data from each of the target functions.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the program instrumentation technique implementations described herein will become better understood with regard to the following description, appended claims, and accompanying drawings where:

FIG. 1 is a diagram illustrating an exemplary implementation, in simplified form, of a system framework for realizing the program instrumentation technique implementations described herein.

FIG. 2 is a flow diagram illustrating an exemplary implementation, in simplified form, of a process for dynamically instrumenting a target computer program to allow telemetry data to be collected from the program while it is running.

FIG. 3 is a flow diagram illustrating an exemplary implementation, in simplified form, of a process for utilizing an instrumentation manifest to automatically insert code into one or more target functions existing within the target computer program that collects one or more types of telemetry data from each of the target functions.

FIG. 4 is a flow diagram illustrating an exemplary implementation, in simplified form, of a process for inserting code into a given one of the target functions that redirects each call to the target function to a telemetry data collection function in the case where the target function is a specific function that is either imported into or exported from the target computer program.

FIG. 5 is a flow diagram illustrating an exemplary implementation, in simplified form, of a process for inserting code into a given one of the target functions that redirects each call to the target function to a telemetry data collection function in the case where the target function is an instruction at the beginning of a specific function that does not support hot-patching and is internal to the target computer program.

FIG. 6 is a flow diagram illustrating an exemplary implementation, in simplified form, of a process for inserting code into a given one of the target functions that redirects each call to the target function to a telemetry data collection function in the case where the target function is a specific instruction in a specific function that is internal to the target computer program, where the specific instruction is specified by an offset from an instruction at the beginning of this specific function.

FIG. 7 is a flow diagram illustrating an exemplary implementation, in simplified form, of a process for dynamically instrumenting one or more computer programs to allow telemetry data to be collected therefrom.

FIG. 8 is a diagram illustrating an exemplary implementation, in simplified form, of a dynamic instrumentation computer program.

FIG. 9 is a diagram illustrating an exemplary implementation, in simplified form, of an instrumentation manifest provisioning computer program.

FIG. 10 is a diagram illustrating a simplified example of a general-purpose computer system on which various implementations and elements of the program instrumentation technique, as described herein, may be realized.

### DETAILED DESCRIPTION

In the following description of program instrumentation technique implementations reference is made to the accompanying drawings which form a part hereof, and in which are shown, by way of illustration, specific implementations in which the program instrumentation technique can be practiced. It is understood that other implementations can be utilized and structural changes can be made without departing from the scope of the program instrumentation technique implementations.

It is also noted that for the sake of clarity specific terminology will be resorted to in describing the program instrumentation technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version”, or “one variant”, or “another variant”, or an “exemplary variant”, or an “alternate variant” means that a particular feature, a particular structure, or particular characteristics described in connection with the implementation/version/variant can be included in at least one implementation of the program instrumentation technique. The appearances of the phrases “in one implementation”, “in another implementation”, “in an exemplary implementation”, “in an alternate implementation”, “in one version”, “in another version”, “in an exemplary version”, “in an alternate version”, “in one variant”, “in another variant”, “in an exemplary variant”, and “in an alternate variant” in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the program instrumentation technique does not inherently indicate any particular order nor imply any limitations of the program instrumentation technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Instrumenting Computer Programs for Telemetry Data Collection

The program instrumentation technique implementations described herein generally involve dynamically (e.g., on-the-fly) instrumenting a target computer program to allow telemetry data to be collected from the program while it is running (e.g., while it is being executed by one or more target computing devices). The term “computer program” is used herein to refer to a collection of software instructions that performs one or more specific tasks when executed by one or more computing devices. Accordingly and as is appreciated in the arts of software programming and computing, a computer program is also known as a software program. As is also appreciated in the arts of software programming and computing, computer programs can be classified along functional lines into two general categories, namely application programs and backend system programs. The term “application program” is used herein to refer to a computer program that is designed to perform one or more specific functions for the benefit of each end-user who runs the program. In other words, an application program is a computer program that is designed to help end-users perform one or more specific activities/tasks when the end-users run the program. Exemplary types of application programs include word processing programs, spreadsheet programs, email programs, personal information management programs, web browser programs, media playback and editing programs, computer-aided design (CAD) programs, and computer-aided engineering (CAE) programs, among many other types of application programs. The term “backend system program” on the other hand is used herein to refer to a computer program that is designed to provide one or more specific services to other computer programs. Backend system programs generally include the computer programs that are dedicated to managing the operation of computing devices themselves (e.g., operating systems, device drivers, file system utilities, user interface utilities, data communication and networking utilities, and the like).

The program instrumentation technique implementations described herein are advantageous for various reasons including, but not limited to, the following. As will be appreciated from the foregoing and the more-detailed description that follows, the program instrumentation technique implementations can be used to dynamically instrument any type of computer program for telemetry data collection. More particularly and by way of example but not limitation, in one implementation of the program instrumentation technique described herein the target computer program that is instrumented is an application program that is launched by a user. In another implementation of the program instrumentation technique the target computer program that is instrumented is a backend system program. The program instrumentation technique implementations can also be used to instrument both released and unreleased computer programs. More particularly, the program instrumentation technique implementations allow a new computer program that has not yet been released to production (e.g., a program that is still in development/alpha-stage testing or beta-stage testing) to be instrumented for telemetry data collection—in this case the collected telemetry data reflects testing usage of the program. The program instrumentation technique implementations also allow a legacy computer program that has already been released to production (e.g., the program has been released to “the wild” for public use) to be instrumented for telemetry data collection—in this case the collected telemetry data reflects real-world usage of the program.

Additionally, the telemetry data that is collected by the program instrumentation technique implementations described herein can be used for a wide range of ad-hoc computer program analytics. By way of example but not limitation, the collected telemetry data can be used to understand (e.g., characterize) the current performance of the target computer program that is instrumented, and identify ways in which this performance may be increased. The collected telemetry data can also be used to diagnose and debug unresponsive events, code execution exceptions, and code execution errors that may occur during the target computer program's execution. The collected telemetry data can also be used to diagnose and debug crashes that may occur during the target computer program's execution. The collected telemetry data can also be used to understand how successful the target computer program is in fulfilling its design goals. The collected telemetry data can also be used to understand how often the target computer program is run online (e.g., in a manner that necessitates the target computing device(s) which is executing the program to be connected to an operational data communication network, and utilizes the network-based features of the program) versus offline (e.g., in a manner that does not necessitate the target computing device(s) which is executing the program to be connected to an operational data communication network, and does not utilize any network-based features of the program).

In the case where the target computer program is an application program and the target computing device is any one of the wide variety of network-enabled end-user computing devices that exist today (examples of which will be described in more detail hereafter), the telemetry data that is collected by the program instrumentation technique implementations described herein can be used to understand how real-world end-users engage with and utilize the application program (e.g., which features and options of the application program do its end-users utilize and how often). The collected telemetry data can also be used to understand the particular end-user computing device configurations that are preferred by the application program's end-users (e.g., which types of end-user computing devices are utilized to run the program, which display screen sizes, resolutions, and orientations are utilized on these devices, which types of user input modalities are utilized to interact with the program, and the like).

Additionally and as will be appreciated from the more-detailed description that follows, the program instrumentation technique implementations described herein provide for a flexible, low cost, and fast turn-around time way to instrument a target computer program for telemetry data collection that minimizes the program performance and program usability impacts to the end-users of the program. More particularly, the program instrumentation technique implementations can instrument a target computer program on-the-fly and deliver instrumented binaries (e.g., instrumented executable images for various computing environments) for the program without having to modify the program's existing source code and binaries and then formally release the modified (e.g., patched) binaries. The program instrumentation technique implementations can also configure the instrumented target computer program to collect many different types of telemetry data from any type of function (e.g., any type of application program interface (API), among other types of functions) that exists within the target computer program. The particular types of telemetry data to be collected are specified by a user in an instrumentation manifest that is described in more detail hereafter. Examples of the different types of telemetry data that can be collected by the program instrumentation technique implementations are also described in more detail hereafter and include, but are not limited to, different types of function usage data and performance data.

The program instrumentation technique implementations described herein, and each instrumented target computer program that is generated thereby, also introduces negligible overhead on the computing resources needed to execute the instrumented target computer program. Additionally, the semantics of each instrumented target computer program generated by the program instrumentation technique implementations are the same as the semantics of the non-instrumented target computer program—in other words, the program instrumentation implementations technique do not change the semantics of the target computer program.

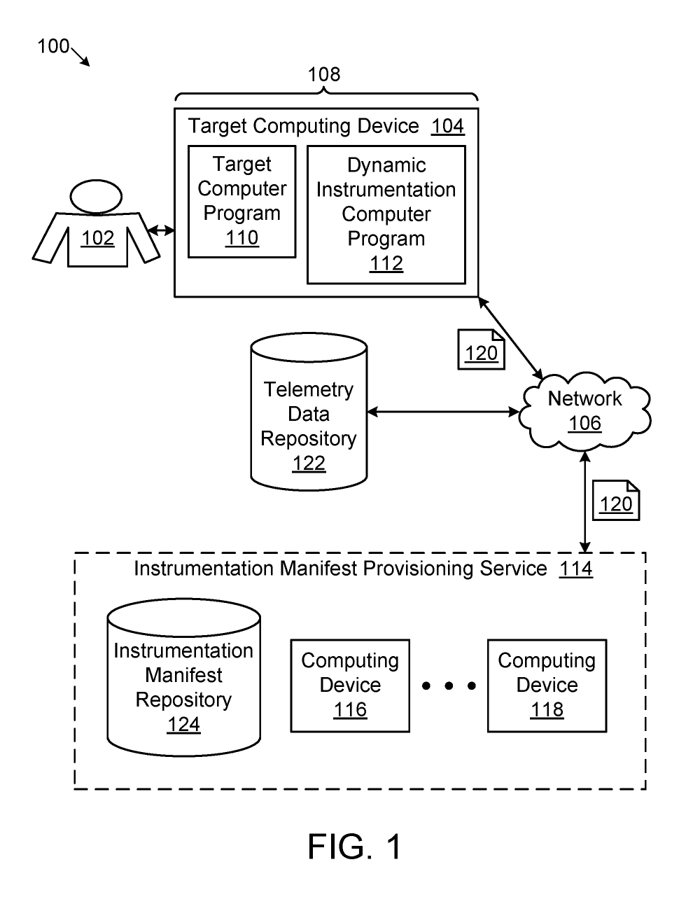

FIG. 1 illustrates an exemplary implementation, in simplified form, of a system framework for realizing the program instrumentation technique implementations described herein. As exemplified in FIG. 1 the system framework 100 includes a target computing device 104 on which the aforementioned target computer program 110 and a dynamic instrumentation computer program 112 are installed. The target computing device 104, target computer program 110, and dynamic instrumentation computer program 112 are herein sometimes collectively referred to as a program instrumentor 108. In an exemplary implementation of the program instrumentation technique described herein the dynamic instrumentation computer program 112 includes a disassembly engine whose use will be described in more detail hereafter. The target computing device 104 is configured to communicate various types of information over a conventional data communication network 106 (herein also referred to as a computer network) such as the Internet (among other types of conventional data communication networks)—examples of such information are described in more detail hereafter. The target computing device 104 can be any type of conventional mobile computing device such as a smartphone, or a tablet computer, or a laptop computer (sometimes also referred to as a notebook or netbook computer), or a computing device that is integrated into an automobile (e.g., a car, or a truck, or any other type of motorized vehicle), among other types of conventional mobile computing devices. The target computing device 104 can also be any type of conventional non-mobile computing device such as a desktop personal computer (PC), or a video game console, or a server computer, among other types of conventional non-mobile computing devices.

Referring again to FIG. 1, the target computer program 110 can be any type of computer program that is executed/run on the target computing device 104. By way of example but not limitation and as described heretofore, the target computer program 110 can be an application program that is launched by a user 102, or the target computer program 110 can be a backend system program. As will be described in more detail hereafter, the dynamic instrumentation computer program 112 generally performs a variety of functions associated with dynamically instrumenting the target computer program 110 to allow telemetry data to be collected from the program 110 while it is running. By way of example but not limitation, in a exemplary implementation of the program instrumentation technique described herein the dynamic instrumentation computer program 112 receives an instrumentation manifest 120 that includes user-generated metadata specifying one or more target functions existing within the target computer program 110, where this manifest 120 is “pushed” over the data communication network 106 to the target computing device 104 by an instrumentation manifest provisioning service 114 that is described in more detail hereafter. The metadata in the manifest 120 also specifies for each of the target functions one or more types of telemetry data to be collected from the target function. Exemplary types of target functions and telemetry data that are supported by the program instrumentation technique are described in more detail hereafter. The dynamic instrumentation computer program 112 utilizes the instrumentation manifest 120 to automatically insert code into each of the target functions whenever the target function is executed on the target computing device 104 (e.g., on-the-fly), where this inserted code operates to collect the specified types of telemetry data from each of the target functions. The dynamic instrumentation computer program 112 also stores the telemetry data collected by the inserted code. It will be appreciated that the telemetry data which is collected from the target computer program 110 may be stored locally on the target computing device 104. This telemetry data may also be stored in a telemetry data repository 122 that resides in the cloud (e.g., the telemetry data collected from the target computer program 110 may be transmitted over the data communication network 106 from the target computing device 104 to the repository 122).

Referring again to FIG. 1, the target computing device 104 and the telemetry data repository 122 are configured to communicate over the data communication network 106 with the aforementioned instrumentation manifest provisioning service 114 that runs on one or more other computing devices 116/118. These other computing devices 116/118 can also communicate with each other via the network 106. In an exemplary implementation of the program instrumentation technique described herein the other computing devices 116/118 are located in the cloud so that the instrumentation manifest provisioning service 114 operates as a cloud service and the network 106 includes wide area network functionality. The term “cloud service” is used herein to refer to a web application that operates in the cloud and can be hosted on (e.g., deployed at) a plurality of data centers that can be located in different geographic regions (e.g., different regions of the world).

Referring again to FIG. 1 and as will be described in more detail hereafter, the instrumentation manifest provisioning service 114 generally performs a variety of functions associated with dynamically instrumenting one or more computer programs to allow telemetry data to be collected from these programs while they are running. By way of example but not limitation, in a exemplary implementation of the program instrumentation technique described herein the instrumentation manifest provisioning service 114 receives via the data communication network 106 a request from the target computing device 104 to instrument the target computer program 110 installed on the device 104 for telemetry data collection, and in response to this request the manifest provisioning service 114 transmits the aforementioned instrumentation manifest 120 over the network 106 to the target computing device 104. In other words, the target computing device 104 “pulls” the instrumentation manifest 120 from the instrumentation manifest provisioning service 114. The instrumentation manifest 120 is utilized to automatically insert code into each of the target functions specified in the manifest 120 whenever the target function is executed on the device 104, where this inserted code operates to collect the types of telemetry data specified in the manifest 120 from each of the target functions. The instrumentation manifest provisioning service 114 may then receive via the network 106 the telemetry data that is collected by the inserted code, and may store this collected telemetry data in the telemetry data repository 122. It is noted that the instrumentation manifest provisioning service 114 can dynamically instrument many different computer programs to allow telemetry data to be collected from these programs. It is also noted that two or more of these different computer programs may be installed on one target computing device (e.g., the target computer program 104, among other target computer programs (not shown), installed on the target computing device 104), and others of these different computer programs may be installed on other target computing devices (not shown). The instrumentation manifest provisioning service 114 may include an instrumentation manifest repository 124 that is used to store the instrumentation manifest (e.g., manifest 120) that is used to instrument each of the different computer programs.

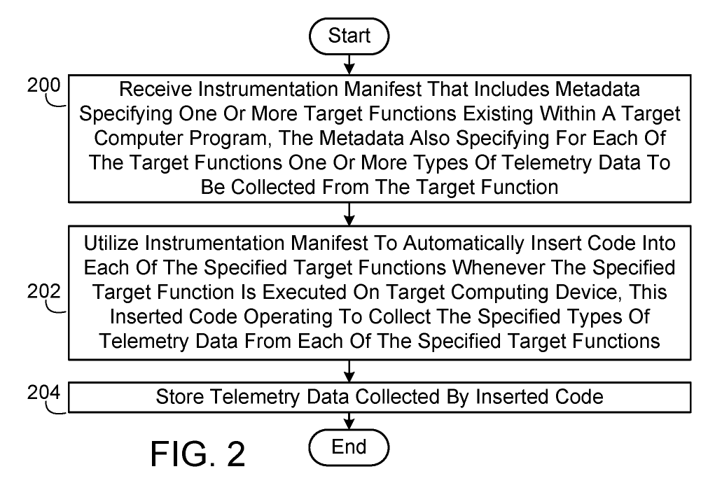

FIG. 2 illustrates an exemplary implementation, in simplified form, of a process for dynamically instrumenting a target computer program to allow telemetry data to be collected from the program while it is running. In an exemplary implementation of the program instrumentation technique described herein the process illustrated in FIG. 2 is realized on the target computing device 104 illustrated in FIG. 1. As exemplified in FIG. 2 the process starts with receiving an instrumentation manifest that includes user-generated metadata specifying one or more target functions existing within the target computer program, the metadata also specifying for each of the target functions one or more types of telemetry data to be collected from the target function (process action 200). The instrumentation manifest is then utilized to automatically insert code into each of the target functions whenever the target function is executed on the target computing device, where this inserted code operates to collect the specified types of telemetry data from each of the target functions (process action 202), and the telemetry data collected by the inserted code is stored (process action 204). Given the foregoing and the more-detailed description that follows, it will be appreciated that the combination of actions 200 and 202 has the advantageous effect of enhancing the operation of the target computing device by providing telemetry data from the target computer program that allows bugs, performance issues, and other unintended operational deficiencies in this program to be diagnosed and corrected.

As is appreciated in the arts of software programming and computing, the source code for a given computer program is coded (e.g., written) using a prescribed programming language, and is then compiled into a set of executable files that are designed to be installed into and executed in a prescribed computing environment (e.g., on a prescribed type of computing device that is running a prescribed type of operating system and is configured with a prescribed amount of physical memory)—these executable files are often referred to as object code, or binary files (or binaries for short). A given computer program generally consists of a variety of different modules that interact with each other and collectively form the program. In the case where module A needs to use a function B that is defined in module C, module A will import the function B from module C—function B is herein considered to be an imported function. In the case where module A defines a function D and exposes the function D so that it can be used by other modules, function D is herein considered to be an exported function. In the case where module A defines another function E that is intended to be used just inside module A (in other words, function E is neither an imported function nor an exported function), function E is herein considered to be an internal function.

In one implementation of the program instrumentation technique described herein the target functions specified by the metadata in the instrumentation manifest (hereafter sometimes simply referred to as the specified target functions) include a specific function that is imported into the target computer program. In another implementation of the program instrumentation technique the specified target functions include a specific function that is exported from the target computer program. In another implementation of the program instrumentation technique the specified target functions include the instruction at the beginning of a specific function (e.g., the first instruction of the specific function) that supports hot-patching and is internal to the target computer program (i.e., the specific function is neither imported into nor exported from the target computer program). A specific function that is internal to the target computer program is hereafter sometimes simply referred to as a specific internal function. The term “hot-patching” in the context of a function is described in more detail hereafter. In another implementation of the program instrumentation technique the specified target functions include the instruction at the beginning of a specific internal function that does not support hot-patching.

In another implementation of the program instrumentation technique described herein the specified target functions include a specific instruction in a specific internal function, where this specific instruction is specified by an offset from the instruction at the beginning of the specific internal function. Given the foregoing, it will be appreciated that the just-described offset is part of the metadata that is included in the instrumentation manifest. As will be appreciated from the more-detailed description that follows, the just-described specific instruction can be any instruction in the specific internal function other than the first instruction thereof (e.g., the just-described specific instruction may be an instruction in the middle of the specific internal function, or an instruction toward the end of the specific internal function, among other places in the specific internal function).

In one version of the aforementioned implementation of the program instrumentation technique described herein where the target computer program is an application program that is launched by a user (hereafter sometimes simply referred to as the application program implementation), the specified target functions may include a specific API that is that is imported into the application program. In another version of the application program implementation the specified target functions may include a specific API that is exported from the application program. In another version of the application program implementation the specified target functions may include a specific API that is internal to the application program (i.e., an API that is neither imported into nor exported from the application program). In another version of the application program implementation the specified target functions may include a specific instruction in a specific API that is internal to the application program, where this specific instruction is specified by an offset from the instruction at the beginning of the this internal API. Given the foregoing, it will be appreciated that the just-described offset is part of the metadata that is included in the instrumentation manifest. As will be appreciated from the more-detailed description that follows, the just-described specific instruction can be any instruction in the internal API other than the first instruction thereof (e.g., the just-described specific instruction may be an instruction in the middle of the internal API, or an instruction toward the end of the internal API, among other places in the internal API).

The aforementioned instrumentation manifest can be easily generated by any user. For example, in the case where the target computer program has not yet been released to production, the manifest may be generated by a software engineer who is responsible for the program's source code, or by a test engineer who is responsible for performing quality assurance testing on the program. In the case where the target computer program has already been released to production, the manifest may be generated by a person who is responsible for providing customer support for the program, or by a software engineer who wants to understand how the program is currently being used in order to determine modifications to make or new features to add in a future version of the program. The manifest may be generated on any computing device regardless of whether or not the target computer program is installed on this computing device. For example, the manifest may be generated on any end-user (e.g., client) computing device, or the manifest may be generated in the cloud.

In a tested implementation of the program instrumentation technique described herein the instrumentation manifest is realized as follows. The aforementioned metadata (that specifies the target functions existing within the target computer program from which telemetry data is to be collected, and the types of telemetry data that are to be collected from each of these specified target functions) is packaged (e.g., encapsulated) into a dynamic instrument manifest file (e.g., a .dim file) designed to support the program instrumentation technique. Referring again to FIG. 1, in the case where the instrumentation manifest 120 is generated on the target computing device 104 itself, the manifest 120 may be stored on this device 120, or the manifest may be “pushed” to the cloud (e.g., stored in the instrumentation manifest repository 124) for subsequent use by the instrumentation manifest provisioning service 114.

Referring again to FIGS. 1 and 2, in an exemplary implementation of the program instrumentation technique described herein where the target computing device 104 is an end-user computing device that is utilized by the user 102, the previously described action 202 includes the following actions. The user 102 of the target computing device 104 is asked to consent to having telemetry data be collected from the target computer program 110, and also consent to having the collected telemetry data be transmitted to the cloud. In the case where these consents are received from the user 102, the instrumentation manifest 120 will then be utilized to automatically insert code into each of the specified target functions in the target computer program 110 whenever the specified target function is executed on the target computing device 104, where this inserted code collects the specified types of telemetry data from each of the specified target functions. In the case where the user 102 does not consent, no code will be inserted into the specified target functions so that a non-instrumented version of the program 110 is run that does not collect any telemetry data from the program 110.

As described heretofore, the program instrumentation technique implementations described herein can collect many different types of telemetry data, where, for each of the specified target functions, the particular types of telemetry data to be collected from the specified target function are specified by the metadata in the instrumentation manifest. In one implementation of the program instrumentation technique described herein the types of telemetry data to be collected from a given specified target function include the value of one or more specific parameters appearing in the specified target function. Referring again to FIG. 2, it will be appreciated that since the aforementioned action 202 inserts code into the specified target function to collect the value of the just-described specific parameters appearing in the specified target function, this inserted code will be executed each time the specified target function is called. Thus, the value of these specific parameters will be collected each time the specified target function is called. In another implementation of the program instrumentation technique the types of telemetry data to be collected from a given specified target function include how many times the specified target function is called. In another implementation of the program instrumentation technique where the target computer program is an application program that is launched by a given user, the types of telemetry data to be collected from a given specified target function include information identifying the user.

In another implementation of the program instrumentation technique described herein the types of telemetry data to be collected from a given specified target function include one or more specific attributes of the target computing device (e.g., computing environment data)—this particular implementation is hereafter sometimes simply referred to as the attributes implementation. In one version of the attributes implementation the specific attributes of the target computing device include the type of operating system that is running on the target computing device. In another version of the attributes implementation the specific attributes of the target computing device include the version of this operating system. In another version of the attributes implementation the specific attributes of the target computing device include the amount of physical memory (herein also referred to as system memory) that is installed on the target computing device.

As is appreciated in the art of computing, and as will be described in more detail hereafter, the target computing device includes one or more processing units that are configured to execute each of the programs and related sub-programs that are installed on the target computing device. As such, in another version of the attributes implementation the specific attributes of the target computing device include the type of each of the processing units. In another version of the attributes implementation the specific attributes of the target computing device include the operating speed of each of the processing units. In another version of the attributes implementation the specific attributes of the target computing device include the total number of processing units.

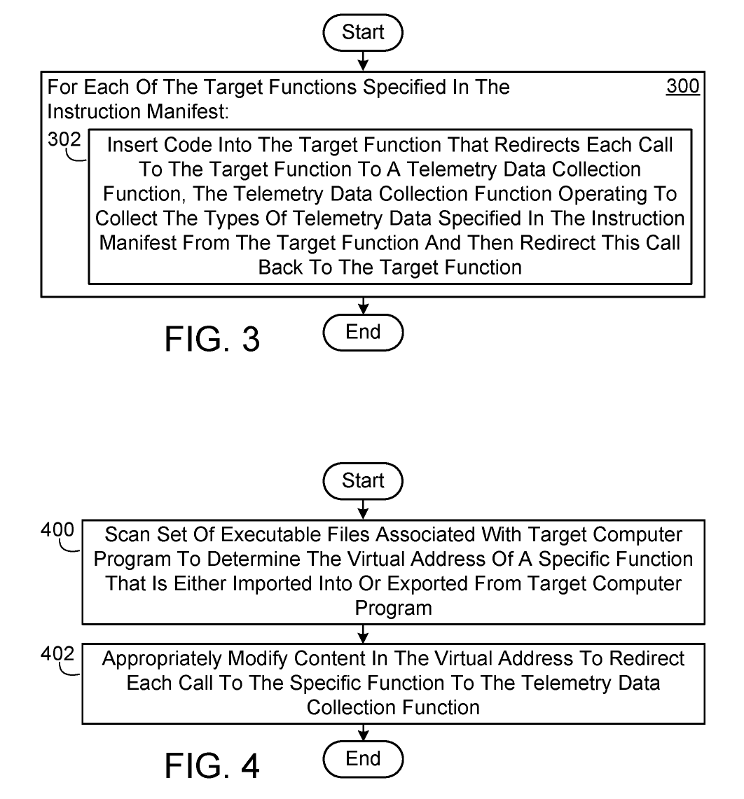

FIG. 3 illustrates an exemplary implementation, in simplified form, of a process for utilizing the instrumentation manifest to automatically insert code into each of the target functions specified in the manifest whenever the specified target function is executed on the target computing device, where this inserted code collects the types of telemetry data specified by the metadata in the manifest from each of the specified target functions. In other words, FIG. 3 illustrates an exemplary implementation of the action 202 that is shown in FIG. 2. The types of telemetry data specified by the metadata in the instruction manifest to be collected from a given specified target function are hereafter sometimes simply referred to as the specified types of telemetry data. As exemplified in FIG. 3 the process performs the following action for each of the specified target functions (process action 300). Code is inserted into the specified target function that redirects each call to the specified target function to a telemetry data collection function, where the telemetry data collection function operates to collect the specified types of telemetry data from the specified target function and then redirects this call back to the specified target function (process action 302). It will be appreciated that this action 302 allows the specified types of telemetry data to be collected from the specified target function in a manner that is transparent both the specified target function and the target computer program.

FIG. 4 illustrates an exemplary implementation, in simplified form, of a process for inserting code into a given target function that redirects each call to the target function to the just-described telemetry data collection function in the case where the target function is a specific function that is either imported into or exported from the target computer program. In other words, FIG. 4 illustrates an exemplary implementation of the action 302 that is shown in FIG. 3 in the case where the target function is a specific function that is either imported into or exported from the target computer program. As exemplified in FIG. 4 the process starts with scanning the set of executable files that is associated with the target computer program to determine the virtual address of the just-described specific function (process action 400). The content in the virtual address is then appropriately modified to redirect each call to the specific function to the telemetry data collection function (process action 402). It is noted that in a tested implementation of the program instrumentation technique described herein the virtual address for each function that is imported into or exported from the target computer program is stored in the header of the executable file associated with the imported or exported function—in this case action 402 will appropriately modify this header to redirect each call to the imported or exported function to the telemetry data collection function.

Referring again to FIG. 3, in the case where a given target function is the instruction at the beginning of a specific internal function that supports hot-patching, in an exemplary implementation of the program instrumentation technique described herein action 302 includes the action of patching a two-byte jump instruction at the top of this specific internal function, where the target address of this jump instruction is the beginning of the telemetry data collection function. As is appreciated in the arts of software programming and computing, the term “hot-patching” generally refers to patching a given process by inserting a substitute function into the process at run-time (e.g., when the process is run/executed). Accordingly, function A supports hot-patching (e.g., function A is hot-patchable) if function A allows a substitute function to be inserted into function A when it is run/executed. In a tested implementation of the program instrumentation technique a specific function will support hot-patching whenever room for a two-byte jump instruction is allocated at the top of the function. In a tested version of this particular implementation a function that supports hot-patching will have the following two one-byte instructions at the top of the function: “db 0x48”; “push rbp”. It will be appreciated that the “db 0x48” instruction is a one-byte REX (register extension) prefix that does nothing. More particularly, the REX prefix “db 0x48” specifies that the prefixed instruction “push rbp” will use an operand size of 64-bits. The “push rbp” instruction is a one-byte instruction that defaults to a 64-bit operand size, so that the “db 0x48” instruction means and also does nothing. Thus, the just-described two one-byte instructions create a two-byte pad that leaves room for the foregoing two-byte jump instruction to be patched at the top of the function.

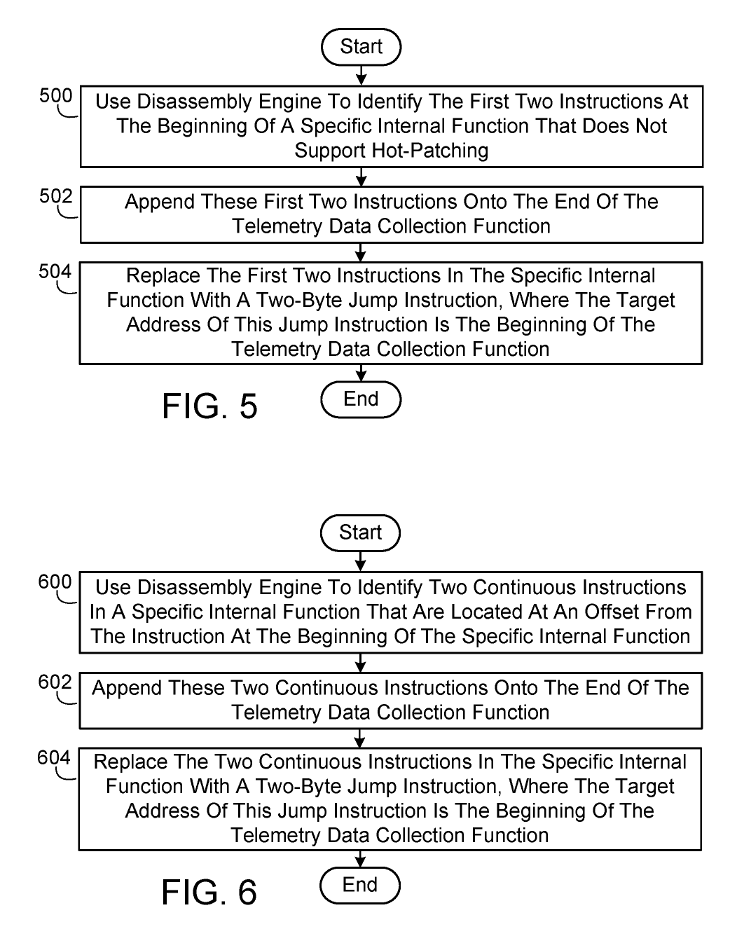

FIG. 5 illustrates an exemplary implementation, in simplified form, of a process for inserting code into a given target function that redirects each call to the target function to the telemetry data collection function in the case where the target function is the instruction at the beginning of a specific function that does not support hot-patching and is internal to the target computer program. In other words, FIG. 5 illustrates an exemplary implementation of the action 302 that is shown in FIG. 3 in the case where the target function is the instruction at the beginning of a specific internal function that does not support hot-patching. As exemplified in FIG. 5 the process starts with using the aforementioned disassembly engine to identify the first two instructions at the beginning of this specific internal function (process action 500). These first two instructions are then appended onto the end of the telemetry data collection function (process action 502). The first two instructions in the specific internal function are then replaced with a two-byte jump instruction, where the target address of this jump instruction is the beginning of the telemetry data collection function (process action 504).

FIG. 6 illustrates an exemplary implementation, in simplified form, of a process for inserting code into a given target function that redirects each call to the target function to the telemetry data collection function in the case where the target function is a specific instruction in a specific function that is internal to the target computer program, where the specific instruction is specified by an offset from the instruction at the beginning of this specific function. In other words, FIG. 5 illustrates an exemplary implementation of the action 302 that is shown in FIG. 3 in the case where the target function is a specific instruction in a specific internal function, where the specific instruction is specified by an offset from the instruction at the beginning of the specific internal function. As exemplified in FIG. 6 the process starts with using the disassembly engine to identify two continuous instructions in the specific internal function that are located at the just-described offset (process action 600). These two continuous instructions are then appended onto the end of the telemetry data collection function (process action 602). These two continuous instructions in the specific internal function are then replaced with a two-byte jump instruction, where the target address of this jump instruction is the beginning of the telemetry data collection function (process action 604). As described heretofore, the offset is part of the metadata that is included in the instrumentation manifest. In a tested implementation of the program instrumentation technique described herein action 600 was realized as follows. An instruction pointer address was calculated by adding the offset to the starting address (e.g., the base address) of an executable file associated with the specific internal function, where this calculated pointer address points to the two continuous instructions in the specific internal function that are located at the offset.

It will be appreciated that the telemetry data collection function described herein can be realized in various ways. For example, in one implementation of the program instrumentation technique described herein the telemetry data collection function associated with each of the target functions specified in the instrumentation manifest is generated dynamically as needed (e.g., whenever the target function is executed) on the target computing device using conventional methods, so that each of the target functions will be redirected to its corresponding telemetry data collection function whenever the target function is called. In another implementation of the program instrumentation technique a common telemetry data collection function having a plurality of entry points is generated using conventional methods, where each of these entry points supports a different one of the target functions specified in the instrumentation manifest, so that each of the target functions will be redirected to a different one of the entry points whenever the target function is called.

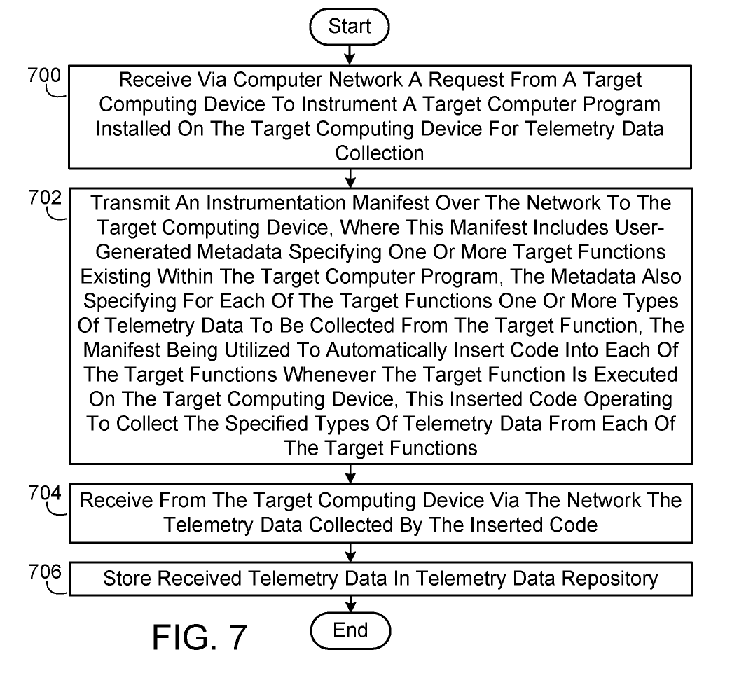

FIG. 7 illustrates an exemplary implementation, in simplified form, of a process for dynamically instrumenting one or more computer programs to allow telemetry data to be collected therefrom. In an exemplary implementation of the program instrumentation technique described herein the process illustrated in FIG. 7 is realized on the one or more other computing devices 116/118 illustrated in FIG. 1. As exemplified in FIG. 7 the process starts with receiving via the aforementioned data communication network a request from a target computing device to instrument a target computer program installed on the target computing device for telemetry data collection (process action 700). An instrumentation manifest is then transmitted over the network to the target computing device, where this manifest includes user-generated metadata specifying one or more target functions existing within the target computer program, the metadata also specifying for each of the target functions one or more types of telemetry data to be collected from the target function, and where the manifest is utilized to automatically insert code into each of the target functions whenever the target function is executed on the target computing device, this inserted code operating to collect the specified types of telemetry data from each of the target functions (process action 702). The telemetry data that is collected by the inserted code is then received from the target computing device via the network (process action 704). This received telemetry data may then be stored in the aforementioned telemetry data repository (process action 706). Given the foregoing, it will be appreciated that action 702 has the advantageous effect of enhancing the operation of the target computing device by providing telemetry data from the target computer program that allows bugs, performance issues, and other unintended operational deficiencies in this program to be diagnosed and corrected.

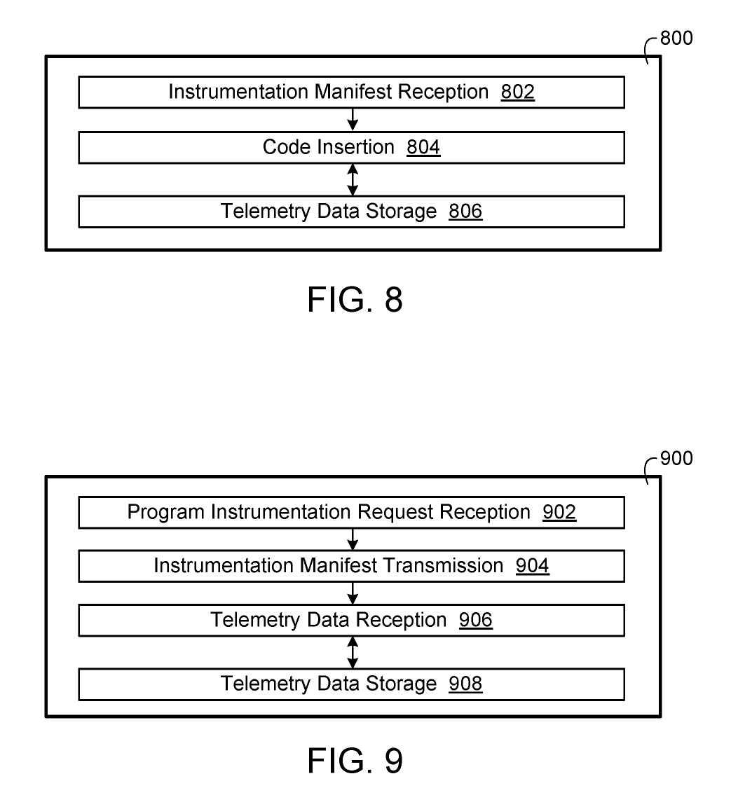

FIG. 8 illustrates an exemplary implementation, in simplified form, of a dynamic instrumentation computer program. As exemplified in FIG. 8, and referring again to FIG. 2, the dynamic instrumentation computer program 800 includes, but is not limited to, an instrumentation manifest reception sub-program 802 that performs action 200, a code insertion sub-program 804 that performs action 202, and a telemetry data storage sub-program 806 that performs action 204. Each of the just-described sub-programs is realized on a computing device such as that which is described in more detail in the Exemplary Operating Environments section which follows. More particularly and by way of example but not limitation, and referring again to FIG. 1, in an exemplary implementation of the program instrumentation technique described herein the just-described sub-programs may be realized on the target computing device 104.

FIG. 9 illustrates an exemplary implementation, in simplified form, of an instrumentation manifest provisioning computer program. As exemplified in FIG. 9, and referring again to FIG. 7, the instrumentation manifest provisioning computer program 900 includes, but is not limited to, a program instrumentation request reception sub-program 902 that performs action 700, an instrumentation manifest transmission sub-program 904 that performs action 702, a telemetry data reception sub-program 906 that performs action 704, and a telemetry data storage sub-program 908 that performs action 706. Each of the just-described sub-programs is realized on a computing device such as that which is described in more detail in the Exemplary Operating Environments section which follows. More particularly and by way of example but not limitation, and referring again to FIG. 1, in an exemplary implementation of the program instrumentation technique described herein the just-described sub-programs may be realized on the one or more other computing devices 116/118.

### 2.0 Other Implementations

While the program instrumentation technique has been described by specific reference to implementations thereof, it is understood that variations and modifications thereof can be made without departing from the true spirit and scope of the program instrumentation technique. It is noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

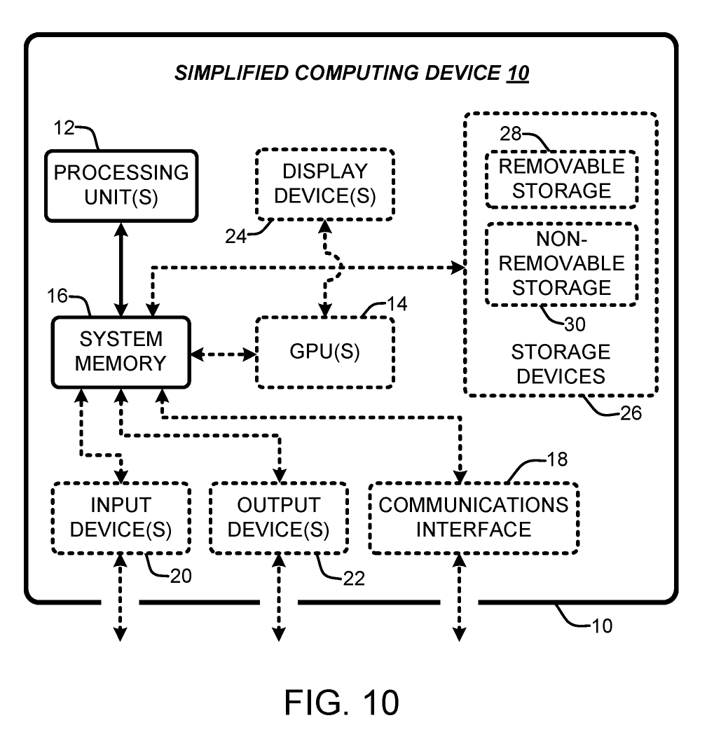

The program instrumentation technique implementations described herein are operational within numerous types of general purpose or special purpose computing system environments or configurations. FIG. 10 illustrates a simplified example of a general-purpose computer system on which various implementations and elements of the program instrumentation technique, as described herein, may be implemented. It is noted that any boxes that are represented by broken or dashed lines in the simplified computing device 10 shown in FIG. 10 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the program instrumentation technique implementations described herein, the device should have a sufficient computational capability and system memory to enable basic computational operations. In particular, the computational capability of the simplified computing device 10 shown in FIG. 10 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the program instrumentation technique implementations described herein, including input, output, control, feedback, and response to one or more users or other devices or systems associated with the program instrumentation technique implementations, are enabled by a variety of Natural User Interface (NUI) scenarios. The NUI techniques and scenarios enabled by the program instrumentation technique implementations include, but are not limited to, interface technologies that allow one or more users user to interact with the program instrumentation technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the program instrumentation technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the program instrumentation technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 10 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various program instrumentation technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The program instrumentation technique implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The program instrumentation technique implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for instrumenting a target computer program to allow telemetry data to be collected therefrom, comprising:
a program instrumentor comprising a computing device on which the target computer program is installed, and an instrumentation computer program having a plurality of sub-programs executable by said computing device, wherein the sub-programs configure said computing device to,
receive an instrumentation manifest comprising metadata specifying one or more target functions existing within the target computer program, the metadata also specifying for each of the target functions one or more types of telemetry data to be collected from the target function,
utilize the instrumentation manifest to insert code into each of the target functions whenever the target function is executed on the computing device, said inserted code operating to collect the specified types of telemetry data from each of the target functions, and
store the telemetry data collected by the inserted code.

2. The system of claim 1, wherein the target computer program comprises an application program and the target functions comprise one or more of:
a specific application program interface (API) that is imported into the application program; or
a specific API that is exported from the application program; or
a specific API that is internal to the application program.

3. The system of claim 1, wherein the target computer program comprises an application program and the target functions comprise a specific instruction in a specific application program interface (API) that is internal to the application program, said specific instruction being specified by an offset from an instruction at a beginning of the said internal API.

4. The system of claim 1, wherein the types of telemetry data to be collected from the target function comprise the value of one or more specific parameters appearing in the target function.

5. The system of claim 1, wherein the types of telemetry data to be collected from the target function comprise how many times the target function is called.

6. The system of claim 1, wherein the types of telemetry data to be collected from the target function comprise one or more specific attributes of the computing device.

7. The system of claim 6, wherein the specific attributes of the computing device comprise one or more of:
a type of operating system that is running on the computing device; or
a version of said operating system; or
an amount of physical memory that is installed on the computing device.

8. The system of claim 6, wherein the computing device comprises one or more processing units configured to execute the sub-programs, and the specific attributes of the computing device comprise one or more of:
a type of each of the processing units; or
an operating speed of each of the processing units; or
the total number of processing units.

9. The system of claim 1, wherein the target computer program comprises an application program that is launched by a user, and the types of telemetry data to be collected from the target function comprise information identifying the user.

10. The system of claim 1, wherein the sub-program for utilizing the instrumentation manifest to insert code into each of the target functions whenever the target function is executed on the computing device comprises a sub-program for:
for each of the target functions,
inserting code into the target function that redirects each call to the target function to a telemetry data collection function, the telemetry data collection function operating to collect the specified types of telemetry data from the target function and then redirect said call back to the target function.

11. The system of claim 10, wherein the target function comprises a specific function that is imported into the target computer program, and the sub-program for inserting code into the target function that redirects each call to the target function to a telemetry data collection function comprises sub-programs for:
scanning a set of executable files associated with the target computer program to determine a virtual address of said specific function; and
appropriately modifying content in said virtual address to redirect said call to the telemetry data collection function.

12. The system of claim 10, wherein the target function comprises a specific function that is exported from the target computer program, and the sub-program for inserting code into the target function that redirects each call to the target function to a telemetry data collection function comprises sub-programs for:
scanning a set of executable files associated with the target computer program to determine a virtual address of said specific function; and
appropriately modifying content in said virtual address to redirect said call to the telemetry data collection function.

13. The system of claim 10, wherein the target function comprises an instruction at a beginning of a specific function that supports hot-patching and is internal to the target computer program, and the sub-program for inserting code into the target function that redirects each call to the target function to a telemetry data collection function comprises a sub-program for patching a two-byte jump instruction at a top of said specific function, a target address of said jump instruction being a beginning of the telemetry data collection function.

14. The system of claim 10, wherein the sub-programs of the instrumentation computer program comprise a disassembly engine, the target function comprises an instruction at a beginning of a specific function that does not support hot-patching and is internal to the target computer program, and the sub-program for inserting code into the target function that redirects each call to the target function to a telemetry data collection function comprises sub-programs for:
using the disassembly engine to identify a first two instructions at the beginning of said specific function;
appending said first two instructions onto an end of the telemetry data collection function; and
replacing said first two instructions in said specific function with a two-byte jump instruction, a target address of said jump instruction being a beginning of the telemetry data collection function.

15. The system of claim 10, wherein the sub-programs of the instrumentation computer program comprise a disassembly engine, the target function comprises a specific instruction in a specific function that is internal to the target computer program, the specific instruction being specified by an offset from an instruction at a beginning of said specific function, and the sub-program for inserting code into the target function that redirects each call to the target function to a telemetry data collection function comprises sub-programs for:
using the disassembly engine to identify two continuous instructions in said specific function located at said offset;
appending said two continuous instructions onto an end of the telemetry data collection function; and
replacing said two continuous instructions in said specific function with a two-byte jump instruction, a target address of said jump instruction being a beginning of the telemetry data collection function.

16. The system of claim 1, wherein the sub-program for storing the telemetry data collected by the inserted code comprises a sub-program for transmitting the telemetry data collected by the inserted code over a computer network to a telemetry data repository.

17. The system of claim 1, wherein the target computer program comprises one of:
an application program; or
a backend system program.

18. A system for instrumenting one or more computer programs to allow telemetry data to be collected therefrom, comprising:
an instrumentation manifest provisioner comprising one or more computing devices, said computing devices being in communication with each other via a computer network whenever there is a plurality of computing devices, and a computer program having a plurality of sub-programs executable by said computing devices, wherein the sub-programs configure said computing devices to,
receive via the computer network a request from a target computing device to instrument a target computer program installed on the target computing device for telemetry data collection, and
transmit an instrumentation manifest over the computer network to the target computing device, said manifest comprising metadata specifying one or more target functions existing within the target computer program, the metadata also specifying for each of the target functions one or more types of telemetry data to be collected from the target function, said manifest being utilized to automatically insert code into each of the target functions whenever the target function is executed on the target computing device, said inserted code operating to collect the specified types of telemetry data from each of the target functions.

19. The system of claim 18, wherein the sub-programs further configure said computing devices to receive from the target computing device via the computer network the telemetry data collected by the inserted code.

20. A computer-implemented process for instrumenting a target computer program to allow telemetry data to be collected therefrom, the process comprising the actions of:
receiving an instrumentation manifest comprising metadata specifying one or more target functions existing within a target computer program, the metadata also specifying for each of the target functions one or more types of telemetry data to be collected from the target function,
utilizing the instrumentation manifest to insert code into each of the target functions whenever the target function is executed, said inserted code operating to collect the specified types of telemetry data from each of the target functions, and
storing the telemetry data collected by the inserted code.
